(19) United States
(12) Patent Application Publication
(10) Pub. No.: US 2024/0313455 A1
(43) Pub. Date: Sep. 19, 2024

(54) SOCKET TERMINAL, SOCKET CONNECTOR AND CONNECTOR ASSEMBLY

(71) Applicant: Samsung Display Co., LTD., Yongin-si (KR)

(72) Inventor: SUN-KYO JUNG, Yongin-si (KR)

(21) Appl. No.: 18/542,015

(22) Filed: Dec. 15, 2023

(30) Foreign Application Priority Data
Mar. 14, 2023 (KR) 10-2023-0033307

(51) Int. Cl. H01R 13/11; H01R 13/20

(52) U.S. Cl. CPC H01R 13/11; H01R 13/20

(57) ABSTRACT

A socket terminal includes a first end extending in a first direction, a first curved portion extending from the first end in the first direction and curved in a second direction intersecting the first direction, a second curved portion extending from the first curved portion in the first direction and curved in a third direction opposite to the second direction, a third curved portion extending from the second curved portion in the first direction and curved in the third direction, and a second end extending from the third curved portion in a direction opposite to the first direction and curved at least twice.

This application claims priority to Korean Patent Application No. 10-2023-0033307, filed on Mar. 14, 2023, and all the benefits accruing therefrom under 35 U.S.C. § 119, the content of which in its entirety is herein incorporated by reference.

### BACKGROUND

### 1. Field

Embodiments relate to a socket terminal. More specifically, embodiments relate to a socket terminal, and a socket connector and a connector assembly including the socket terminal.

### 2. Description of the Related Art

A display device may provide a user with an image that has predetermined information. The display device may include a display module that displays an image and a driving module that provides a driving signal to the display module.

Before combining the display module and the driving module to form a display device, an inspection process may be performed to check whether the display module is normally driven. This inspection process may be performed by providing a test signal from an inspection module to the display module to check whether the display module is normally driven.

In order to electrically connect the display module to an external module such as the inspection module, each of the display module and the external module may include a connector. The connector of the display module and the connector of the external module may form a connector assembly.

### SUMMARY

Embodiments provide a socket terminal with improved driving failure.

Embodiments provide a socket connector including the socket terminal.

Embodiments provide a connector assembly including the socket terminal.

A socket terminal according to an embodiment of the disclosure includes a first end extending in a first direction, a first curved portion extending from the first end in the first direction and curved in a second direction intersecting the first direction, a second curved portion extending from the first curved portion in the first direction and curved in a third direction opposite to the second direction, a third curved portion extending from the second curved portion in the first direction and curved in the third direction, and a second end extending from the third curved portion in a direction opposite to the first direction and curved at least twice.

In an embodiment, the second end may include a first bent portion extending from the third curved portion and curved in the second direction, and a second bent portion extending from the first bent portion and curved in the third direction.

In an embodiment, the second end may have an S-like shape.

In an embodiment, the second end may have an L-like shape.

A socket connector according to an embodiment of the disclosure includes a mold portion defining an inner space, and socket terminals disposed in the inner space of the mold portion. Each of the socket terminals may include a first end extending in a first direction, a first curved portion extending from the first end in the first direction and curved in a second direction intersecting the first direction, a second curved portion extending from the first curved portion in the first direction and curved in a third direction opposite to the second direction, a third curved portion extending from the second curved portion in the first direction and curved in the third direction, and a second end extending from the third curved portion in a direction opposite to the first direction and curved at least twice.

In an embodiment, the second end may include a first bent portion extending from the third curved portion and curved in the second direction, and a second bent portion extending from the first bent portion and curved in the third direction.

In an embodiment, the second end may have an S-like shape.

In an embodiment, the second end may have an L-like shape.

In an embodiment, the mold portion may cover at least a portion of the first end.

In an embodiment, an inner surface of the first curved portion may be spaced apart from the mold portion.

In an embodiment, an inner surface of the first curved portion may contact the mold portion.

In an embodiment, the mold portion may include a bottom portion, a first sidewall and a second sidewall opposite to each other, where each of the first sidewall and the second sidewall protrudes from the bottom portion in the second direction and facing each other, and a third sidewall and a fourth sidewall intersecting the first sidewall and the second sidewall, and opposite to each other, where each of the third sidewall and the fourth sidewall protrudes from the bottom portion in the second direction.

In an embodiment, the socket terminals may protrude from the first sidewall and the second sidewall.

A connector assembly according to an embodiment of the disclosure includes a socket connector including a mold portion defining an inner space and socket terminals disposed in the inner space of the mold portion, and a plug connector including plug terminals coupled to the socket terminals, respectively. In such an embodiment, each of the socket terminals may include a first end extending in a first direction, a first curved portion extending from the first end in the first direction and curved in a second direction intersecting the first direction, a second curved portion extending from the first curved portion in the first direction and curved in a third direction opposite to the second direction, a third curved portion extending from the second curved portion in the first direction and curved in the third direction, and a second end extending from the third curved portion in a direction opposite to the first direction and curved at least twice.

In an embodiment, each of the plug terminals may contact the first curved portion and the second end.

In an embodiment, the second end may include a first bent portion extending from the third curved portion and curved in the second direction, and a second bent portion extending from the first bent portion and curved in the third direction.

In an embodiment, each of the plug terminals may contact the first curved portion, the first bent portion and the second bent portion.

In an embodiment, the second end may have an S-like shape.

In an embodiment, the second end may have an L-like shape.

In an embodiment, an inner surface of the first curved portion may contact the mold portion.

In a connector assembly according to embodiments of the disclosure, a socket connector may include socket terminals in which each one end is curved twice or more. The one end of each of the socket terminals may have an S-like shape or an L-like shape in a cross-sectional view. The socket connector and a plug connector may be electrically connected as the socket terminals contact plug terminals at at least three contact points, respectively. Accordingly, contact failure between the socket terminal and the plug terminal may be effectively prevented, and a driving failure rate in an inspection process may be effectively prevented.

### BRIEF DESCRIPTION OF THE DRAWINGS

FIG. 1 is a plan view illustrating a socket connector according to an embodiment of the disclosure.

FIG. 2 is a cross-sectional view taken along line I-I′ of FIG. 1 according to an embodiment of the disclosure.

FIG. 3 is a cross-sectional view illustrating a connector assembly including the socket connector of FIG. 2.

FIG. 4 is a cross-sectional view illustrating another example of FIG. 2.

FIG. 5 is a cross-sectional view taken along line I-I′ of FIG. 1 according to an alternative embodiment of the disclosure.

FIG. 6 is a cross-sectional view illustrating a connector assembly including the socket connector of FIG. 5.

FIG. 7 is a cross-sectional view illustrating another example of FIG. 5.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in more detail with reference to the accompanying drawings. The same reference numerals are used for the same components in the drawings, and any repetitive detailed descriptions of the same components will be omitted or simplified.

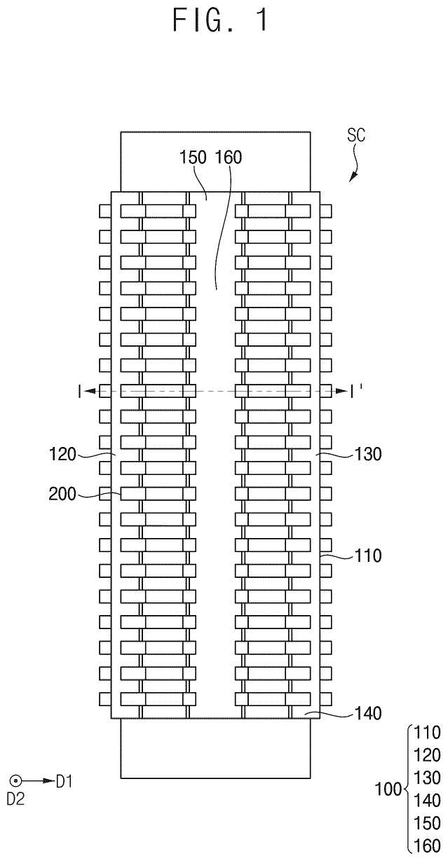

FIG. 1 is a plan view illustrating a socket connector according to an embodiment of the disclosure.

Referring to FIG. 1, a first direction D1 and a second direction D2 intersecting the first direction D1 may define a plane. For example, the first direction D1 and the second direction D2 may be perpendicular to each other.

An embodiment of a socket connector SC may include a mold portion 100 and a plurality of socket terminals 200.

The mold portion 100 may include an insulating material such as plastic or the like. The mold portion 100 may include a bottom portion 110, and a first sidewall 120, a second sidewall 130, a third sidewall 140, a fourth sidewall 150 and a pillar 160 vertically protruding from the bottom portion 110. In an embodiment, for example, the first, second, third and fourth sidewalls 120, 130, 140 and 150 and the pillar 160 may protrude from the bottom portion 110 in the second direction D2.

The first sidewall 120 and the second sidewall 130 may be opposite to each other, and the third sidewall 140 and the fourth sidewall 150 may be opposite to each other. The first sidewall 120 and the second sidewall 130 may intersect the third sidewall 140 and the fourth sidewall 150, respectively. In such an embodiment, the first, second, third and fourth sidewalls 120, 130, 140 and 150 may be connected to each other. The pillar 160 may be disposed between the first sidewall 120 and the second sidewall 130. The pillar 160 may face each of the first sidewall 120 and the second sidewall 130.

The mold portion 100 may define an inner space. In an embodiment, the bottom portion 110 and the first, second, third and fourth sidewalls 120, 130, 140 and 150 may define the inner space. The inner space may be separated or divided with the pillar 160 interposed therebetween.

The socket terminals 200 may be disposed in the inner space of the mold portion 100. The socket terminals 200 may be arranged in two rows between the first sidewall 120 and the second sidewall 130. Some of the socket terminals 200 may be disposed between the first sidewall 120 and the pillar 160, and the others of the socket terminals 200 may be disposed between the second sidewall 130 and the pillar 160.

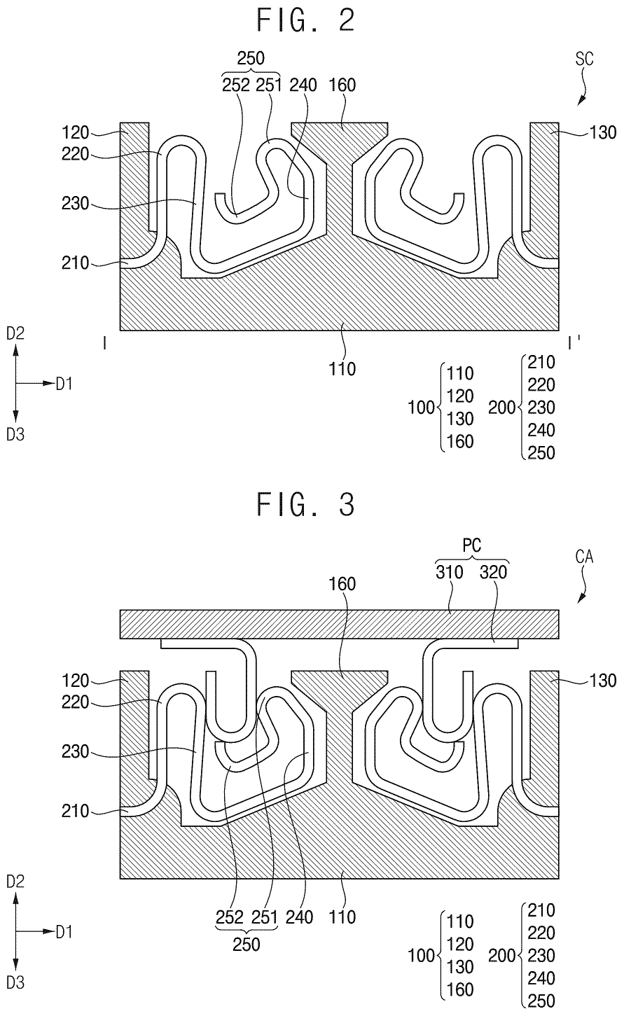

FIG. 2 is a cross-sectional view taken along line I-I′ of FIG. 1 according to an embodiment of the disclosure. Particularly, FIG. 2 may be a cross-sectional view of the socket terminals 200 included in the socket connector SC.

Referring to FIG. 2, in an embodiment, the socket terminals 200 may be disposed in the inner space of the mold portion 100. In an embodiment, for example, the socket terminals 200 may protrude toward the inner space from the first sidewall 120 and the second sidewall 130. The socket terminals 200 may have symmetrical shapes with respect to the pillar 160.

Each of the socket terminals 200 may include a first end 210, a first curved portion 220, a second curved portion 230, a third curved portion 240 and a second end 250.

The first end 210 may extend in the first direction D1. The first end 210 may protrude from the mold portion 100. In an embodiment, for example, the first end 210 may protrude from the first sidewall 120. At least a portion of the first end 210 may be covered by the mold portion 100.

The first curved portion 220 may extend from the first end 210 in the first direction D1. In addition, the first curved portion 220 may be further curved in the second direction D2. That is, the first curved portion 220 may be bent convexly upward (i.e., in the second direction D2). In an embodiment, an inner surface of the first curved portion 220 may be spaced apart from the mold portion 100.

The second curved portion 230 may extend from the first curved portion 220 in the first direction D1. In addition, the second curved portion 230 may be further curved in a third direction D3 opposite to the second direction D2. That is, the second curved portion 230 may be bent convexly downward (i.e., in the third direction D3).

The third curved portion 240 may extend from the second curved portion 230 in the first direction D1. In addition, the third curved portion 240 may be further curved in the second direction D2. That is, the third curved portion 240 may be bent convexly downward (i.e., in the third direction D3).

The second end 250 may extend from the third curved portion 240 in a direction opposite to the first direction D1. The second end 250 may include a first bent portion 251 and a second bent portion 252.

The first bent portion 251 may extend from the third curved portion 240 in the direction opposite to the first direction D1. In addition, the first bent portion 251 may be further curved in the second direction D2. That is, the first bent portion 251 may be bent convexly upward (i.e., in the second direction D2).

The second bent portion 252 may extend from the first bent portion 251 in the direction opposite to the first direction D1. In addition, the second bent portion 252 may be further curved in the third direction D3. That is, the second bent portion 252 may be bent convexly downward (i.e., in the third direction D3).

In an embodiment, as the first bent portion 251 may be curved in the second direction D2 and the second bent portion 252 may be curved in the third direction D3, the second end 250 may have an S-like shape in a cross-sectional view.

In an embodiment, a shape of the socket terminal 200 protruding from the second sidewall 130 and a shape of the socket terminal 200 protruding from the first sidewall 120 may be symmetrical with respect to the pillar 160. Accordingly, the socket terminal 200 protruding from the second sidewall 130 may have substantially the same shape as the socket terminal 200 protruding from the first sidewall 120.

Each of the socket terminals 200 may include a conductive material. In an embodiment, for example, each of the socket terminals 200 may include a metal including copper or the like, but the disclosure is not limited thereto.

FIG. 3 is a cross-sectional view illustrating a connector assembly including the socket connector of FIG. 2.

Referring to FIG. 3, in an embodiment, a connector assembly CA may include the socket connector SC and a plug connector PC. The connector assembly CA may include a pair of connectors.

The socket connector SC may include the mold portion 100 and the socket terminals 200. The plug connector PC may include a mold portion 310 and a plurality of plug terminals 320. The socket connector SC may be coupled to the plug connector PC.

The mold portion 310 may include an insulating material such as plastic or the like. The plug terminals 320 may be disposed on the mold portion 310. The plug terminals 320 may correspond to the socket terminals 200 on a one-to-one basis. In an embodiment, for example, the plug terminals 320 may be arranged in two rows on the mold portion 310. Each of the plug terminals 320 may include a conductive material.

The socket connector SC may be disposed in a display module, and the plug connector PC may be disposed in an inspection module. Accordingly, the connector assembly CA may be referred to as a board to board connector. In a state where the plug connector PC of the inspection module is coupled to the socket connector SC of the display module, an inspection of the display module may be performed. A test signal may be generated from a control circuit included in the inspection module, and the test signal may be transmitted to the display module. The display module may display an image based on the test signal, and accordingly, whether or not the display module operates normally may be inspected.

When the plug connector PC is coupled to the socket connector SC, the plug terminals 320 may be coupled to the socket terminals 200 in a one-to-one correspondence. When the plug terminal 320 is coupled to the socket terminal 200, the plug connector PC and the socket connector SC may be electrically connected to each other. In an embodiment, for example, where the plug terminal 320 is a power terminal, the socket terminal 200 may input or output a power electrical signal. In an alternative embodiment, for example, where the plug terminal 320 is a signal terminal, the socket terminal 200 may input or output a data electrical signal.

The plug terminal 320 may contact and be coupled to the socket terminal 200. In an embodiment, for example, the plug terminal 320 may be inserted into a space between the first curved portion 220 and the second end 250 of the socket terminal 200 in a cross-sectional view. That is, the plug terminal 320 may contact each of the first curved portion 220 and the second end 250. In an embodiment, the plug terminal 320 and the socket terminal 200 may contact each other at three contact points. In an embodiment, for example, the plug terminal 320 may contact each of the first curved portion 220, the first bent portion 251 and the second bent portion 252 of the socket terminal 200. As the plug terminal 320 contacts the first curved portion 220, the first bent portion 251 and the second bent portion 252, respectively, the socket connector SC and the plug connector PC may be electrically connected to each other.

In an embodiment, the socket terminal 200 may have elasticity. In such an embodiment, when the plug terminal 320 is inserted, the socket terminal 200 may be elastically deformed to prevent the plug terminal 320 from being pulled out. FIG. 3 illustrates a shape of an embodiment of the plug terminals 320, but the shape of the plug terminals 320 is not limited thereto.

In the connector assembly CA according to an embodiment of the disclosure, the socket connector SC may include the socket terminals 200 in which the second end 250 has an S-like shape in a cross-sectional view. As the socket terminals 200 contact with the plug terminals 320 at three or more contact points, respectively, the socket connector SC and the plug connector PC may be electrically connected to each other. Accordingly, contact failure between the socket terminal 200 and the plug terminal 320 may be effectively prevented.

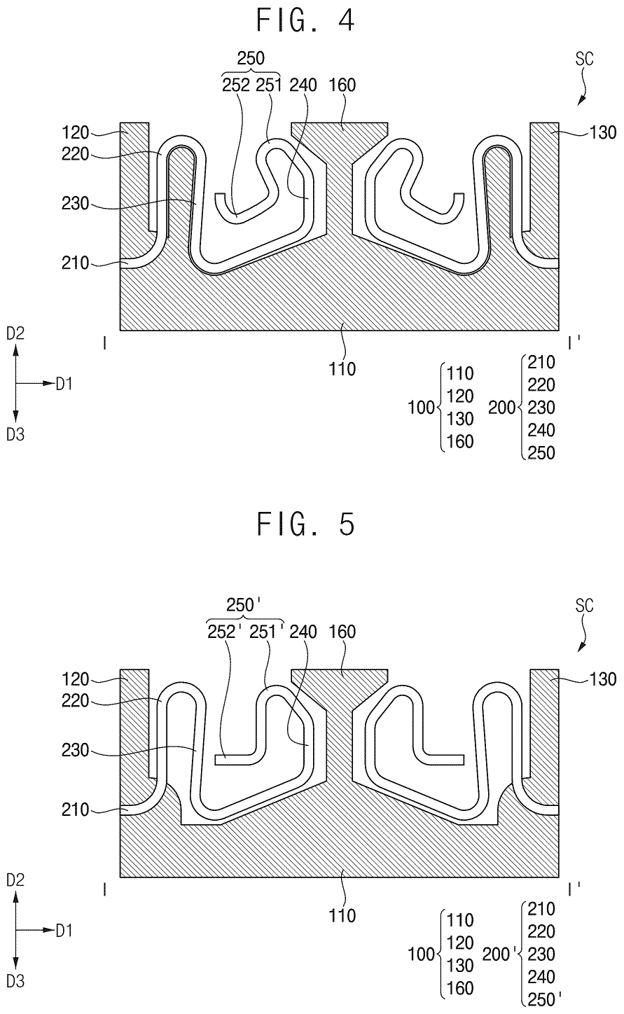

FIG. 4 is a cross-sectional view illustrating another example of FIG. 2.

However, a socket connector SC described with reference to FIG. 4 may be substantially the same as or similar to the socket connector SC described with reference to FIG. 2 except for a cross-sectional shape of the mold portion 100. Hereinafter, any repetitive detailed descriptions of the same or like elements as those of the socket connector SC described with reference to FIG. 2 will be omitted or simplified.

Referring to FIG. 4, in an embodiment, the socket connector SC may include the mold portion 100 and the socket terminals 200.

The socket terminals 200 may be disposed in the inner space of the mold portion 100. Each of the socket terminals 200 may include the first end 210, the first curved portion 220, the second curved portion 230, the third curved portion 240 and the second end 250.

In an embodiment, the inner surface of the first curved portion 220 may contact the mold portion 100. The mold portion 100 may fix the first curved portion 220. That is, the mold portion 100 may fill a space where the first curved portion 220 is bent toward the second direction D2. In an embodiment, for example, a portion of the bottom portion 110 may extend in the second direction D2 to contact the inner surface of the first curved portion 220.

FIG. 5 is a cross-sectional view taken along line I-I′ of FIG. 1 according to an alternative embodiment of the disclosure. Particularly, FIG. 5 may be a cross-sectional view of socket terminals 200′ included in the socket connector SC.

A socket connector SC shown in FIG. 5 may be substantially the same as or similar to the socket connector SC described with reference to FIG. 2 except for a shape of the socket terminal 200′. Hereinafter, any repetitive detailed descriptions of the same or like elements as those of the socket connector SC described with reference to FIG. 2 will be omitted or simplified.

Referring to FIGS. 1 and 5, in an embodiment, the socket connector SC may include the mold portion 100 and a plurality of socket terminals 200′.

The mold portion 100 may include the bottom portion 110, the first sidewall 120, the second sidewall 130, the third sidewall 140, the fourth sidewall 150 and the pillar 160. The first, second, third and fourth sidewalls 120, 130, 140 and 150 and the pillar 160 may protrude from the bottom portion 110 in the second direction D2.

The mold portion 100 may define the inner space, and the inner space may be separated with the pillar 160 interposed therebetween.

The socket terminals 200′ may be disposed in the inner space of the mold portion 100. The socket terminals 200′ may be arranged in two rows between the first sidewall 120 and the second sidewall 130. The socket terminals 200′ may have symmetrical shapes with respect to the pillar 160.

Each of the socket terminals 200′ may include the first end 210, the first curved portion 220, the second curved portion 230, the third curved portion 240 and a second end 250′.

The first end 210 may protrude from the mold portion 100, and may extend in the first direction D1. The first curved portion 220 may extend from the first end 210 in the first direction D1, and may be further curved in the second direction D2. In an embodiment, the inner surface of the first curved portion 220 may be spaced apart from the mold portion 100.

The second curved portion 230 may extend from the first curved portion 220 in the first direction D1, and may be further curved in the third direction D3. The third curved portion 240 may extend from the second curved portion 230 in the first direction D1, and may be further curved in the third direction D3.

The second end 250′ may extend from the third curved portion 240 in the direction opposite to the first direction D1. The second end 250′ may include a first bent portion 251′ and a second bent portion 252′.

The first bent portion 251′ may extend from the third curved portion 240 in the direction opposite to the first direction D1. In addition, the first bent portion 251′ may be further curved in the second direction D2. That is, the first bent portion 251′ may be bent convexly upward (i.e., in the second direction D2).

The second bent portion 252′ may extend from the first bent portion 251′ in the direction opposite to the first direction D1. In addition, the second bent portion 252′ may be further curved in the third direction D3. In an embodiment, for example, the second bent portion 252′ may be curved vertically from the first bent portion 251′. That is, the second bent portion 252′ may be bent downward (i.e., in the third direction D3).

In an embodiment, as the first bent portion 251′ may be curved in the second direction D2 and the second bent portion 252′ may be curved in the third direction D3, the second end 250′ may have an L-like shape in a cross-section view.

In an embodiment, a shape of the socket terminal 200′ protruding from the second sidewall 130 and a shape of the socket terminal 200′ protruding from the first sidewall 120 may be symmetrical with respect to the pillar 160. Accordingly, the socket terminal 200′ protruding from the second sidewall 130 may have substantially the same shape as the socket terminal 200′ protruding from the first sidewall 120.

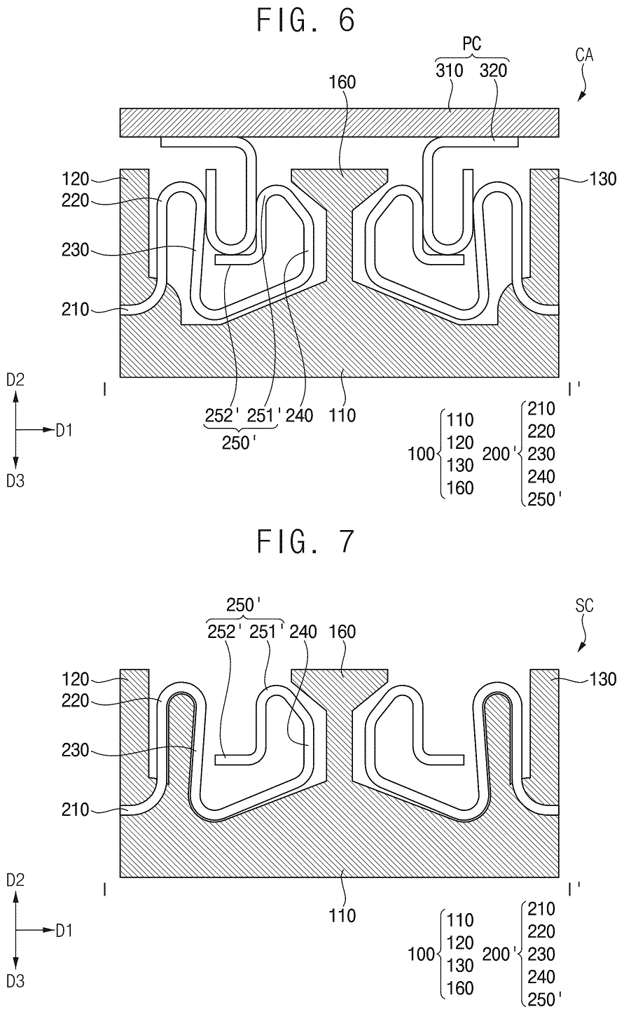

FIG. 6 is a cross-sectional view illustrating a connector assembly including the socket connector of FIG. 5.

A connector assembly CA shown in FIG. 6 may be substantially the same as or similar to the connector assembly CA described with reference to FIG. 3 except for a shape of the socket terminal 200′. Hereinafter, any repetitive detailed descriptions of the same or like elements as those of the connector assembly CA described with reference to FIG. 3 will be omitted or simplified.

Referring to FIG. 6, in an embodiment, the connector assembly CA may include the socket connector SC and the plug connector PC. The socket connector SC may include the mold portion 100 and the socket terminals 200′. The plug connector PC may include the mold portion 310 and the plug terminals 320. The plug connector PC may be coupled to the socket connector SC. In such an embodiment, the plug terminals 320 may be coupled to the socket terminals 200′ in a one-to-one correspondence.

The plug terminal 320 may contact and be coupled to the socket terminal 200′. In an embodiment, for example, the plug terminal 320 may be inserted into a space between the first curved portion 220 and the second end 250′ of the socket terminal 200 in a cross-sectional view. That is, the plug terminal 320 may contact each of the first curved portion 220 and the second end 250′. In an embodiment, the plug terminal 320 and the socket terminal 200′ may contact each other at three contact points. In an embodiment, for example, the plug terminal 320 may contact each of the first curved portion 220, the first bent portion 251′ and the second bent portion 252′ of the socket terminal 200′. As the plug terminal 320 contacts each of the first curved portion 220, the first bent portion 251′ and the second bent portion 252′, the socket connector SC and the plug connector PC may be electrically connected. FIG. 6 illustrates a shape of an embodiment of the plug terminals 320, but the shape of the plug terminals 320 is not limited thereto.

In the connector assembly CA according to an embodiment of the disclosure, the socket connector SC may include the socket terminals 200′ in which the second end 250′ has an L-like shape in a cross-sectional view. As the socket terminals 200′ contact the plug terminals 320 at three or more contact points, respectively, contact failure between the socket terminal 200′ and the plug terminal 320 may be effectively prevented

FIG. 7 is a cross-sectional view illustrating another example of FIG. 5.

A socket connector SC shown in FIG. 7 may be substantially the same as or similar to the socket connector SC described with reference to FIG. 5, except for a cross-sectional shape of the mold portion 100. Hereinafter, any repetitive detailed descriptions of the same or like elements as those of the socket connector SC described with reference to FIG. 5 will be omitted or simplified.

Referring to FIG. 7, in an embodiment, the socket connector SC may include the mold portion 100 and the socket terminals 200′.

The socket terminals 200′ may be disposed in the inner space of the mold portion 100. Each of the socket terminals 200′ may include the first end 210, the first curved portion 220, the second curved portion 230, the third curved portion 240 and the second end 250′.

In an embodiment, the inner surface of the first curved portion 220 may contact the mold portion 100. The mold portion 100 may fix the first curved portion 220. That is, the mold portion 100 may fill a space where the first curved portion 220 is bent toward the second direction D2. In an embodiment, for example, a portion of the bottom portion 110 may extend in the second direction D2 to contact the inner surface of the first curved portion 220.

Embodiments of the disclosure can be applied to various display devices, for example, t display devices for vehicles, ships and aircraft, portable communication devices, display devices for exhibition or information transmission, medical display devices, and the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A socket terminal comprising:
a first end extending in a first direction;
a first curved portion extending from the first end in the first direction and curved in a second direction intersecting the first direction;
a second curved portion extending from the first curved portion in the first direction and curved in a third direction opposite to the second direction;
a third curved portion extending from the second curved portion in the first direction and curved in the third direction; and
a second end extending from the third curved portion in a direction opposite to the first direction and curved at least twice.

2. The socket terminal of claim 1, wherein the second end includes:
a first bent portion extending from the third curved portion and curved in the second direction; and
a second bent portion extending from the first bent portion and curved in the third direction.

3. The socket terminal of claim 1, wherein the second end has an S-like shape.

4. The socket terminal of claim 1, wherein the second end has an L-like shape.

5. A socket connector comprising:
a mold portion defining an inner space; and
socket terminals disposed in the inner space of the mold portion,
wherein each of the socket terminals includes:
a first end extending in a first direction;
a first curved portion extending from the first end in the first direction and curved in a second direction intersecting the first direction;
a second curved portion extending from the first curved portion in the first direction and curved in a third direction opposite to the second direction;
a third curved portion extending from the second curved portion in the first direction and curved in the third direction; and
a second end extending from the third curved portion in a direction opposite to the first direction and curved at least twice.

6. The socket connector of claim 5, wherein the second end includes:
a first bent portion extending from the third curved portion and curved in the second direction; and
a second bent portion extending from the first bent portion and curved in the third direction.

7. The socket connector of claim 5, wherein the second end has an S-like shape.

8. The socket connector of claim 5, wherein the second end has an L-like shape.

9. The socket connector of claim 5, wherein the mold portion covers at least a portion of the first end.

10. The socket connector of claim 5, wherein an inner surface of the first curved portion is spaced apart from the mold portion.

11. The socket connector of claim 5, wherein an inner surface of the first curved portion contacts the mold portion.

12. The socket connector of claim 5, wherein the mold portion includes:
a bottom portion;
a first sidewall and a second sidewall opposite to each other, wherein each of the first sidewall and the second sidewall protrudes from the bottom portion in the second direction; and
a third sidewall and a fourth sidewall intersecting the first sidewall and the second sidewall, and opposite to each other, wherein each of the third sidewall and the fourth sidewall protrudes from the bottom portion in the second direction.

13. The socket connector of claim 12, wherein the socket terminals protrude from the first sidewall and the second sidewall.

14. A connector assembly comprising:
a socket connector including a mold portion defining an inner space and socket terminals disposed in the inner space of the mold portion; and
a plug connector including plug terminals coupled to the socket terminals, respectively,
wherein each of the socket terminals includes:
a first end extending in a first direction;
a first curved portion extending from the first end in the first direction and curved in a second direction intersecting the first direction;
a second curved portion extending from the first curved portion in the first direction and curved in a third direction opposite to the second direction;
a third curved portion extending from the second curved portion in the first direction and curved in the third direction; and
a second end extending from the third curved portion in a direction opposite to the first direction and curved at least twice.

15. The connector assembly of claim 14, wherein each of the plug terminals contacts the first curved portion and the second end.

16. The connector assembly of claim 14, wherein the second end includes:
a first bent portion extending from the third curved portion and curved in the second direction; and
a second bent portion extending from the first bent portion and curved in the third direction.

17. The connector assembly of claim 16, wherein each of the plug terminals contacts the first curved portion, the first bent portion and the second bent portion.

18. The connector assembly of claim 14, wherein the second end has an S-like shape.

19. The connector assembly of claim 14, wherein the second end has an L-like shape.

20. The connector assembly of claim 14, wherein an inner surface of the first curved portion contacts the mold portion.
